(19) United States
(12) Patent Application Publication
(10) Pub. No.: US 2004/0065611 A1
(43) Pub. Date: Apr. 8, 2004

(54) Waste treatment process

(76) Inventor: Ian Jones, Clifton Queensland (AU)

Correspondence Address: Peter Rogalskyj, Rogalskyf & Weyand, PO Box 44, Livonia, NY, 14487-0044, US

(21) Appl. No.: 10/415,441

(22) PCT Filed: Oct. 30, 2001
(86) PCT No.: PCT/AU01/01397

(30) Foreign Application Priority Data
Oct. 30, 2000 (AU) PR 1128

(51) Int. Cl. C02F 3/00

(52) U.S. Cl. 210/607

(57) ABSTRACT

A process of waste treatment which involves: (a) separation of waste material to provide a component having a concentrated solids component and a predominantly liquid component; (b) passing the concentrated solids component through an anaerobic bioreactor system and maintaining insoluble material as a suspension in the concentrated solids component; (c) removing phosphorous and/or nitrogen from the concentrated solids component and/or the predominately liquid component; and (d) removing solids from the concentrated solids component.

### FIELD OF THE INVENTION

THIS INVENTION relates to a waste treatment process and plant, which is suitable for treatment of waste inclusive of biological waste exemplified by faeces, sewage and household waste and commercial and industrial waste.

### BACKGROUND OF THE INVENTION

Reference may be made to International Patent Publication WO 95/25071, which refers to waste treatment plant and process, which includes the steps of:

(i) passing waste material comprising an insoluble component through a bioreactor system including a plurality of bioreactors in series and maintaining said insoluble component as a suspension in said waste material;

(ii) passing treated waste material from said bioreactor system to one or more acidification tanks to reduce the pH below 4.5 to produce free volatile fatty acids for elimination of bacterial pathogens in said treated waste material; and

(iii) separating the insoluble component from the waste material before or after step (ii).

It was an essential feature of the invention disclosed in International Publication WO 95/25071 that after treatment of the waste material in the bioreactor system that the treated waste material was passed to one or more acidification tanks to facilitate the elimination of bacterial pathogens by free volatile fatty acids (VFAs).

In WO 95/25071 the physical removal of phosphorous and/or nitrogen was carried out after acidification by passing a predominantly liquid waste stream through a vertically orientated curtain. However, such physical removal was in a number of cases found to be time consuming and inefficient.

Reference may also be made to U.S. Pat. No. 5,993,503, which refers to a process for removal of phosphorous from fresh manure, which includes the steps of:

(i) storing the fresh manure comprising solids and liquid for a period of at least one month at a temperature between 0-15° C., or for a period of at least one week subjected to continual agitation at a temperature above 15° C., to cause phosphorous to dissolve into the liquid component out of the solids;

(ii) preventing precipitation of phosphate out of the liquid during step (i) by any one of the following methods;

(a) maintaining the manure at a temperature of 0-15° C.;

(b) maintaining the manure at a pH of less than 8;

(c) adding complexing agents for divalent ions;

(d) preventing loss of complexing fatty acids present in the manure;

(e) adding complexing agents for monovalent ions;

(f) adding urease-inhibiting substances; and

(g) adding binding substances; and

(iii) separating the manure into a solid fraction and a liquid fraction and subsequently chemically removing the phosphate from the liquid fraction.

It is noted from U.S. Pat. No. 5,993,503 that chemical removal of the phosphorous only occurs after separation of the manure into a liquid fraction and solid fraction. However, in some cases, this process is not necessary, especially if it is desired to chemically remove phosphorous immediately after agitation of the manure. Also in wastes of relatively low solids content e.g. below 1% w/v an agitation step of the waste prior to chemical removal of the phosphorous is unnecessary and inefficient. Therefore while the process of U.S. Pat. No. 5,993,503 was undoubtedly satisfactory in use it was non-versatile or restricted in application.

### SUMMARY OF THE INVENTION

An object of the invention is to provide a method of waste treatment involving removal of phosphorous and/or nitrogen, which at least reduces the disadvantages of the prior art discussed above.

In accordance with the invention there is provided a process of waste treatment which includes the following steps:

(a) initial separation of the waste to provide a component having a concentrated solids component and a predominantly liquid component;

(b) passing the concentrated solids component through an anaerobic bioreactor system, which optionally includes a plurality of bioreactors in series and maintaining insoluble material as a suspension in the concentrated solids component, whereby optionally the pH of the waste material is maintained below 4.9 for a period of at least 24 hours;

(c) passing the predominantly liquid component to a treatment zone for removal of phosphorous and/or nitrogen after optionally holding the predominantly liquid component in a holding tank or lagoon; and/or

(d) passing the concentrated solids component to a treatment zone for removal of phosphorous and/or nitrogen; and

(e) removing solids from the concentrated solids component.

Preferably an aeration step is carried out in respect of the waste material either before or after step (e). Most preferably the aeration step is carried out after step (e) in respect of the concentrated solids component. The solids removed from the concentrated solids component in step (e) may be used as compost additive, soil conditioner or landfill as appropriate.

In step (a) the waste may have a solids content of 0.5-2.0% w/v. After the concentration step the predominantly solids component may have a solids content of 3.0-8.5% w/v and more usually around 4-6% w/v.

It is preferred to chemically remove nitrogen and/or phosphorous from the predominantly liquid component i.e. step (c) rather than the concentrated solids component, i.e. step (d). However, in most cases, both steps (c) and (d) will be carried out with usually step (d) occurring before step (c) although the reverse may also occur.

It will also be appreciated that the predominantly liquid component may be held in a holding tank or lagoon for a considerable time, 24 hours to several months for example, before nitrogen and phosphorous are removed.

The waste material in some circumstances will have a pH of around 5.3-5.8 and thus may have to be subjected to a pH lowering step when passing through the anaerobic bioreactor system. More preferably, the pH lowering step will take place in a final bioreactor of the bioreactor system. However, it will be appreciated that the pH lowering step may be applied to other bioreactors. However, it will be appreciated that in some circumstances, because of the nature of the waste material, a pH lowering step may not be necessary.

Usually the pH lowering step will involve the addition of a strong mineral acid such as hydrochloric acid, sulphuric acid or nitric acid. However, this does not preclude the use of other acids such as phosphoric acid, perchloric acid or strong organic acids, which will achieve the same effect.

The bioreactor system may comprise a plurality of bioreactors as described in WO 95/25071 the contents of which are totally incorporated herein by reference.

However, as in the case of WO 95/25071, each bioreactor may be interconnected by an overflow conduit so that waste material or effluent is quickly and efficiently transferred from one bioreactor to an adjacent bioreactor without the need for pumping material so as to transfer material from one bioreactor to another. Suitably each bioreactor is provided with agitation means, which keeps the contents of each bioreactor in the form of a slurry or suspension, so that solid particles are maintained in a suspended state.

The contents of each bioreactor may be also subject to heating means and in one form this may be provided by steam being passed into and out of each bioreactor. However, other forms of heating means may be adopted, such as electrical heating. Preferably, the temperature in each bioreactor is maintained by suitably thermostatically controlled means between 25-40° C. and more suitably 30-40° C.

Preferably, the pH of each of the bioreactors is maintained between 5.0-6.0 and more preferably 5.8, except in the case where a pH lowering step is applied to specific bioreactor(s). Preferably, the retention time in each bioreactor may be 12-48 hours, but more suitably is 24 hours.

The waste material, which is subject to the process of the invention, may comprise human or animal faeces and preferably faeces from livestock feedlots, which may have a stockfeed component containing lignocellulose. In fact the process of the invention is extremely efficient in treatment of waste which requires an initial anaerobic fermentation step to break down complex macromolecules such as carbohydrates and proteins to short chain organic acids of 8 carbon atoms or less. Also complex macromolecules such as lipids may be broken down to long chain organic acids of 9 carbon atoms or more and glycerol. This fermentation step usually takes place in the presence of acidogenic fermentative bacteria and lipolytic bacteria which can produce organic acids such as volatile fatty acids and long chain fatty acids, which may be readily metabolised to carbon dioxide and water.

In the initial anaerobic fermentation step use may be made of a series of anaerobic bioreactors as described above which are designed so that oxygen or air is prevented from being introduced into each of the bioreactors. Usually the amount of dissolved oxygen will be very low and be less than 0.7 mg/l. Such bioreactors therefore may be sealed from atmosphere.

After passage through a number of anaerobic reactors, e.g. usually from 2-6 and more preferably from 3-6 and suitably 5 in number, the waste so treated may then be passed to an aerobic tank or aerated system. It may comprise one cell or a plurality of aerobic or aerated cells wherein an air line may supply air or oxygen to aerators or jets, which feed the air under pressure into the cell(s). Usually the aerators may function under diffusion but mechanical aerators may also be utilised. The aerator may be of plug-flow configuration as described in U.S. Pat. No. 5,380,438 or may be of a step-feed and complete-mix aeration configuration or alternatively an activated sludge system.

Most preferably the aeration system may comprise a tank having a submersible pump or agitator in which air is fed into the tank under pressure.

If desired, the waste material after passage from the anaerobic bioreactor system may be subjected to a separation procedure to remove a solid component such as sludge. As stated above, the separation procedure is applied to the waste material preferably prior to aeration. This may be achieved by passing the waste material over a screen, which is subject to the action of wash water above and below the screen, to prevent clogging or blockages occurring in pores or passages located in the screen. Preferably use may be made of a filter system known as the BAYLEEN filter system, which is described in International Publication 98/23357, which is incorporated herein by reference.

### DETAILED DESCRIPTION OF THE DRAWINGS

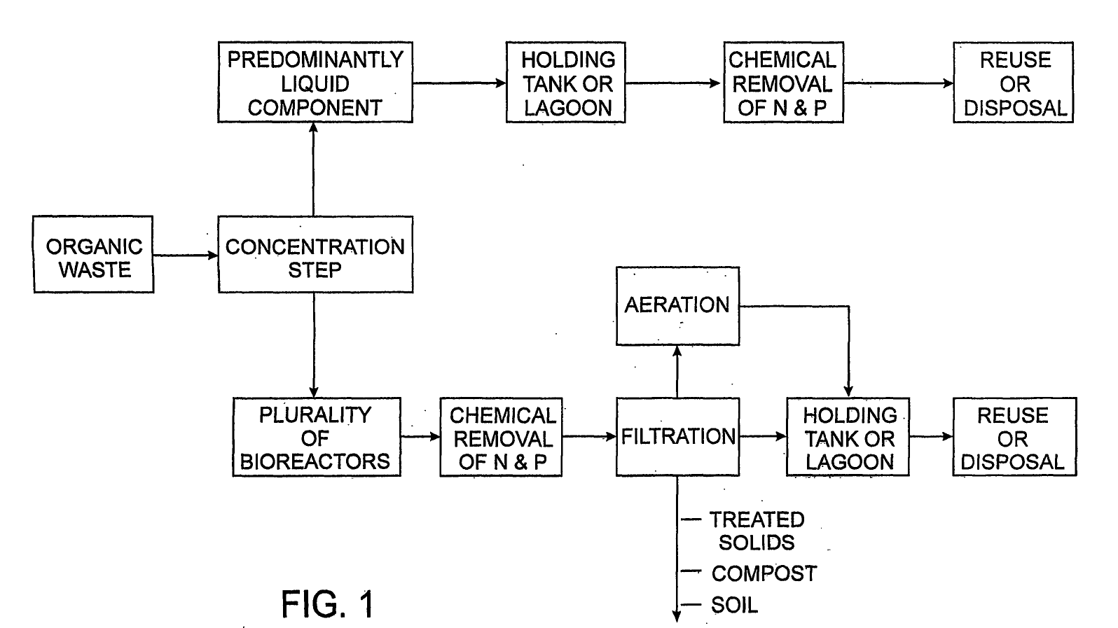

Reference may now be made to a preferred embodiment of the invention shown in FIG. 1, which refers to a flow sheet corresponding to the process of the invention. Clearly the chemical removal of nitrogen and phosphorous in relation to the solids concentrate or the predominantly liquid component may take place in the same treatment zone or tank or different zones or tanks. The aeration step as applied to the solids concentrate after filtration is optional.

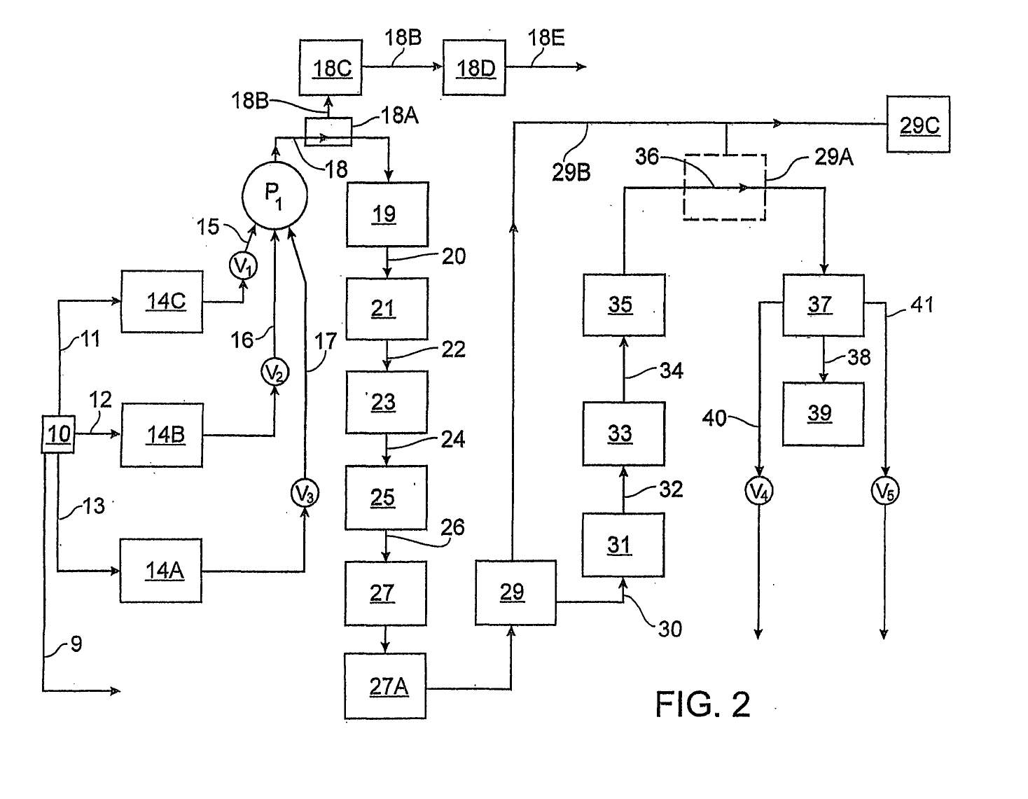

Reference may now be made to another preferred embodiment of the invention as shown in the attached drawing in FIG. 2, wherein initially, faeces from an animal feedlot or commercial or industrial waste, are delivered to a loading bay 10, wherein waste may be conveyed to holding tanks 14A, 14B and 14C along conduits 11, 12 and 13 respectively.

Initially the waste may be passed through a hydrocyclone or centrifugal separator (not shown) to remove large foreign bodies such as spoons, knives, nuts, bolts etc. Loading bay 10 may also comprise a macerator pump for transporting waste to holding tanks 14A, 14B and 14C.

Each of the holding tanks 14A, 14B and 14C may be used for different kinds of waste material e.g. faeces from animal feedlots in tank 14A, dairy waste in tank 14B and sewage waste in tank 14C. Alternatively each tank may be used to store the same kind of waste or mixture of wastes.

After being held for a suitable time (e.g. 0-24 hours) waste from each of tanks 14A, 14B and 14C is pumped by pump P1 along separate conduits 15, 16 and 17, each having valves V1, V2 and V3. Pump P1 after collecting the waste from conduits 15, 16 and 17 may transfer the collected waste to concentration zone 18A through conduit 18.

Alternatively each of conduits 15,16 and 17 may be provided with their own pump for transfer of fluid to concentration zone 18A.

In concentration zone 18A, the waste may be passed through a filter as described herein, parabolic steel screen, or have a flocculating agent such as Alum or Ferric Chloride added thereto or other reagent to concentrate the solids. A solid concentrate may then be passed to bioreactor and predominantly liquid component is passed through a drain (not shown) from zone 18A to holding tank or lagoon 18C through line or conduit 18B. Nitrogen and phosphorous may be removed in treatment tank 18D before being passed out through conduit 18E for reuse or ultimate disposal.

In bioreactor 19 the waste may be maintained at a pH of around 5.0-6.0 or more suitably 5.8. Usually the average dry weight of solid material discharged into bioreactor 19 will be of the order of 3.0-8.5% dry weight w/v and more preferably 5.0% dry weight w/v.

It will be appreciated that when the waste is mainly faeces, such faeces may contain lipolytic bacteria, which hydrolyse triacylglycerols or triglycerides to yield free long chain fatty acids and glycerol and are exemplified by bacteria of the genus Veillonella and Anerovibrio, which are found in faeces.

The faeces may also contain proteolytic bacteria, which convert the majority of the protein to branched chain volatile fatty acids and ammonia nitrogen. Such bacteria may include Bacteroides, Clostridia and Bifidobacterium and are commonly found in faeces.

Saccharolytic bacteria also found in faeces convert carbohydrate to straight chain volatile fatty acids and may include Clostridia, Butyrivibrio, Streptococcus, Bacteroides and Megasphera elsdenii.

Faeces also contain facultative anaerobes, which are active in oxygen rich atmosphere or atmosphere which is depleted in oxygen and are exemplified by Enterobacteriacae. Such bacteria reduce oxygen present in the fermentation liquor.

Faeces also contain hydrolytic fermentative and acid forming bacteria, which produce volatile fatty acids.

Such volatile fatty acids may include acetic acid, proprionic acid, butyric acid, valeric acid, caproic acid, heptanoic acid and octanoic acid. Branched volatile fatty acids may also be produced such as isobutyric acid and isovaleric acid.

In the case of sewage waste there also may be added elements comprising N, S, C, P and K as well as Mg, Ca, Na and Cl⁻. A rich source of N, P and K is agricultural fertiliser inclusive of meatmeal, blood and bone, urea and superphosphate. A preferred source of N is ammonium hydroxide and preferably 0.5-5.0 ml/litre of waste is added to bioreactor 19. Most preferably this is 2 ml/litre. Usually the ammonium hydroxide has a strength of 25% ammonia. It is emphasised that the content of the waste stream entering bioreactor 19 is extremely variable and thus should be monitored to check whether the abovementioned elements should be added. If necessary in the case of sewage waste faeces may be added to bioreactor 19 and this may comprise physiologically active faeces, such as untreated human sewage.

After the waste has been retained in bioreactor 19 for 24 hours, to allow anaerobic fermentation to take place as described above, the waste is then transferred to bioreactors 21, 23, 25 and 27 through lines 20, 22, 24 and 26. When the waste is in bioreactor 27, acid suitably in the form of industrial strength sulphuric acid may be added. This will lower the pH to around 4.0-4.7 and more suitably 4.3 to promote the action of the free VFAs described above in killing bacterial pathogens in the waste. This pH is maintained for a period of at least 24 hours. Preferably 1-10 ml of acid per litre of waste is added and more preferably this is 5 ml/litre. Usually the acid is industrial grade i.e. 50% strength.

After passage through bioreactor 27, the waste may then be passed through treatment zone 27A wherein nitrogen and/or phosphorous may be physically, chemically or biologically removed. In the case of phosphorous, magnesium hydroxide, calcium hydroxide or other alkaline earth metal, hydroxide may be added to the liquid waste to cause precipitation of calcium phosphate or magnesium phosphate. In the case of simultaneous removal of both nitrogen and phosphorous, magnesium hydroxide may be added to the waste which will react with any phosphorous present as well as nitrogen present as ammonia to cause precipitation of struvite i.e. MgNH₄PO₄.6H₂O.

Nitrogen may be captured from the liquid waste by addition of a mineral acid such as sulphuric acid, which may react with any ammonia in the waste to form ammonium sulphate. Nitrogen in the form of ammonia may also be removed by nitrification followed by denitrification e.g. by means of micro-organisms.

The process as described above also applies to treatment zone 18D above.

Reference may also be made to U.S. Pat. No. 5,126,049, which is incorporated herein by reference, which described a number of methods for removal of nitrogen compounds from raw water. These include ion exchange, reversed osmosis, biological dentrification as well as precipitation of struvite.

After passage through tank 27A, the fermented waste including any indigestible solids may be transferred to aeration vessels 31, 33 and 35. However it is emphasised that while a plurality of aeration vessels is illustrated, only a single aeration vessel may be utilised in the context of the present invention. In the aeration vessels aerobic bacteria may be added such as Acinetobacter sp. to remove N and P.. Also appropriate nutrients such as nitrogen and other elements, as described above and in the same concentration, may be added to the aeration vessels so that the volatile fatty acids and long chain acids may be oxidised to carbon dioxide and water. The total time of aeration may be from 2-5 days and more preferably 5 days.

Fermented waste may be transferred to a filter 29 along line 28 before the filtered waste enters aeration vessel 31 through line 30. Filter 29 is preferably a filter known as the BAYLEEN filter described above which is in the form of a stainless steel filter having apertures of around 30-100 microns wherein a fine spray washes solids down the screen for ultimate collection at the base of the screen. Liquid filtrate passes through the apertures. In this filter jets of water are applied downwardly onto the screen and upwardly to inhibit clogging of the apertures.

Alternatively, screw press filters may be used or parabolic stainless steel screens.

Alternatively, after the aerated waste has passed through aeration vessels 31, 33 and 35 through lines 32, 34 and 36 such aerated waste may be subjected to the action of filter 29A after passage of the waste through aerated vessel 35. This alternative may be preferable to use of filter 29 because if filtration takes place prior to aeration, a significant quantity of VFAs and long chain fatty acids may adhere to the separated solids. This may provide a more active sludge for disposal and a weaker or more dilute residue solution to be oxidised by aeration vessels 31, 33 and 35.

Solids may be transported from filter 29 or 29A through line 29B to composting area 29C or transported from the treatment plant.

At the end of aeration, the dry weight solids in the raw waste have been reduced by about 50% and the BOD of the raw waste has been reduced by about 90%.

After passage to liquid holding tank 37 through line 36, the aerated liquid may be held in holding tank 37 for a period of time (12-24 hours) prior to optional passage to tank 39 through line 38. Subsequently the aerated liquid may be transferred through lines 40 and 41 to wetlands or retention ponds as appropriate. Each of lines 40 and 41 are provided with valves V4 and V5.

In FIG. 2 lines 40 and 41 are shown extending from tank 37 and this is appropriate when only a single holding tank is utilised. However, if tank 39 is used, lines 40 and 41 may be connected to this tank rather than tank 37.

In relation to holding tanks 14A, 14B and 14C these may be above ground plastics tanks of 45,000 litre capacity and maintained at a temperature of 20-40° C.

The influent waste material may be piggery flume floor flushings having a solids size range of 2-5 mm. The pH may be 5.8-6.4. The temperature of the influent waste material may be 20-30° C. and have a design flow of around 73.5 l/hour.

Each of the bioreactors 19, 21, 23, 25 and 27 may be of the same structure as described in WO 95/25071 and hence are only shown in schematic form in FIG. 2. The temperature of each of the bioreactors may be maintained at a temperature of 37° C.

1. A process of waste treatment, which includes the following steps:
(a) initial separation of waste material to provide a component having a concentrated solids component and a predominantly liquid component;
(b) passing the concentrated solids component through an anaerobic bioreactor system and maintaining insoluble material in suspension;
(c) passing the predominantly liquid component to a treatment zone for removal of phosphorous and/or nitrogen; and/or
(d) passing the concentrated solid component to a treatment zone for removal of phosphorous and/or nitrogen; and
(e) removing solids from the concentrated solids component.

2. A process as claimed in claim 1, wherein the anaerobic bioreactor system comprises a plurality of bioreactors in series.

3. A process as claimed in claim 1 or 2, wherein the predominantly liquid component is held in a holding tank or lagoon prior to step (c).

4. A process as claimed in any preceding claim, wherein step (c) is omitted and replaced by step (d).

5. A process as claimed in any one of claims 1-3, which includes both steps (c) and (d).

6. A process as claimed in any one of claims 1-3, wherein step (c) is carried out and step (d) is omitted.

7. A process as claimed in claim 5, wherein step (d) is carried out prior to step (c).

8. A process as claimed in any preceding claim, wherein in step (b) the pH of the waste material is maintained below 4.9 for a period of at least 24 hours.

9. A process as claimed in any preceding claim, wherein an aeration step, in respect of the concentrated solids component, is carried out either before or after step (e).

10. A process as claimed in claim 9, wherein the aeration step is carried out after step (e).

11. A process as carried out in any preceding claim, wherein the waste material initially has a solids content of 0.5-2.0% w/v.

12. A process as claimed in any preceding claims, wherein after step (a) the predominantly solids component has a solids content of 3.0-8.5% w/v.

13. A process as claimed in claim 12, wherein the predominantly solids component has a solids content of 4-6% w/v.

14. A process as claimed in claim 3, wherein the predominantly liquid component is held in the holding tank or lagoon for a period of 24 hours to several months.

15. A process as claimed in claim 8, wherein a pH lowering step is necessary to maintain the pH below 4.9.

16. A process as claimed in claim 15, wherein initially the pH is 5.3-6.0 before being lowered below 4.9.

17. A process as claimed in claim 15 or 16, wherein the pH lowering step is applied to a final bioreactor of the bioreactor system..

18. A process as claimed in any one of claims 15, 16 and 17, wherein the pH lowering step involves the addition of a strong mineral acid selected from hydrochloric acid, sulphuric acid or nitric acid to the concentrated solids component.

19. A process as claimed in any one of claims 2-18, wherein the pH of each bioreactor is maintained between 5.0-6.0, except in the case where a pH lowering step is applied to specific bioreactor(s).

20. A process as claimed in any one of claims 2-19, wherein the retention time in each bioreactor is 12-48 hours.

21. A process as claimed in claim 20, wherein the retention time in each bioreactor is 24 hours.

22. A process as claimed in any one of claim 2-21, wherein the temperature employed in each bioreactor is between 25-40° C.

23. A process as claimed in any preceding claim, wherein, in the case of sewage waste, there is provided 0.5-5.0 ml of a nitrogen source, such as ammonium hydroxide, per ml of waste to the bioreactor system.

24. A process as claimed in any preceding claim, whereby in steps (c) and (d) magnesium oxide is added to the waste to cause precipitation of struvite. MgNH₄PO₄H₂O.

25. A process as claimed in any preceding claim, wherein nitrogen is removed from liquid waste by addition of sulphuric acid, which reacts with ammonia present in the liquid waste to form ammonium sulphate.
